(19) United States
(12) Patent Application Publication
(10) Pub. No.: US 2011/0035802 A1
(43) Pub. Date: Feb. 10, 2011

(54) REPRESENTING VIRTUAL OBJECT PRIORITY BASED ON RELATIONSHIPS

(75) Inventors: Nelson S. Arajujo, JR., Redmond, WA (US); Robert M. Fries, Kirkland, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/537,426

(22) Filed: Aug. 7, 2009

(51) Int. Cl. G06F 21/00; G06F 9/455

(52) U.S. Cl. 726/23; 718/1

(57) ABSTRACT

Methods, systems, and computer-readable media are disclosed for representing virtual object priority based on relationships. A particular method determines relationships between a plurality of virtual objects. An abnormal condition is detected at a first virtual object. A second virtual object and a third virtual object are identified based on respective relationships with the first virtual object. The method includes generating an output that identifies the first, second, and third virtual object. The output indicates a priority level for each of the virtual objects, and the priority level for the second virtual object is greater than the priority level for the third virtual object.

### BACKGROUND

Virtual machines are software constructs that typically operate on a computing device to emulate a hardware or software system other than the hardware and software system of the computing device. For example, virtual machines may be used to simulate various hardware configurations and operating system implementations while testing computer source code. Thus, virtual machines may allow multi-platform source code to be tested at a single computing device.

The virtual environments deployed in modern enterprises often include hundreds if not thousands of virtual objects such as virtual machines and virtual machine templates. These virtual objects may change quickly, making it difficult for system administrators to track the changes in an efficient manner. In addition, emergency situations such as computer virus outbreaks may occasionally occur. System administrators usually need to act as fast as possible in response to such emergency situations, to prevent damage due to the emergency from spreading across the virtual environment. However, system administrators are often without any indication of where to start looking for problems and in what order the hundreds if not thousands of virtual objects should be examined.

### SUMMARY

The present disclosure describes prioritizing virtual objects based on their relationship to a malfunctioning object, to help diagnose and repair or bypass the malfunctioning object. Relationships between virtual objects (e.g., virtual machines, virtual machine templates, floppy images, and ISOs) are determined. When an abnormal condition (e.g., a security compromise or malware infection) is detected at a particular virtual object, other virtual objects are prioritized based on their relationship with the particular virtual object. An output (e.g., a graph or a prioritized list) is generated that identifies the virtual objects and the priorities of the virtual objects. The output may be used to diagnose, contain, and cure the abnormal condition.

The priority level for a virtual object may be based on a likelihood that the abnormal condition has affected the virtual object and a relative importance (e.g., mission-critical, optional, etc.) of the virtual object. When virtual objects are prioritized so that virtual objects that are more likely to be affected by the abnormal condition are prioritized over virtual objects that are less likely to be affected, examining the virtual objects in decreasing order of priority may improve the efficiency with which the abnormal condition is diagnosed, cured, and contained. When the output is a graph, the priority levels may be represented by indications such as color, border, or typeface.

As system administrators respond to the detected abnormal condition, the system administrators may provide input regarding virtual objects that have been verified as “safe” or “compromised.” Based on the input, the graph or prioritized list may be “rebalanced.” That is, the priority levels of virtual objects may be updated based on the input.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram to illustrate a particular embodiment of a system of represent virtual object priority based on relationships;

FIG. 2 is a block diagram to illustrate another particular embodiment of a system to represent virtual object priority based on relationships;

FIG. 3 is a graph of an illustrative representation of virtual object priority based on relationships;

FIG. 4 is a graph to illustrate a rebalancing of the graph of FIG. 3 due to updated virtual object priorities;

FIG. 5 is a flow diagram to illustrate a particular embodiment of a method of representing virtual object priority based on relationships;

FIG. 6 is a flow diagram to illustrate another particular embodiment of a method of representing virtual object priority based on relationships;

FIG. 7 is a flow diagram to illustrate another particular embodiment of a method of representing virtual object priority based on relationships;

FIG. 8 is a flow diagram to illustrate another particular embodiment of a method of representing virtual object priority based on relationships; and

FIG. 9 is a block diagram of a computing environment including a computing device operable to support embodiments of computer-implemented methods, computer program products, and system components as illustrated in FIGS. 1-8.

### DETAILED DESCRIPTION

When a virtual object is created, relationships between the created virtual object and existing virtual objects may be stored. In this fashion, relationships of virtual objects in an object topology may be known. When a particular virtual object malfunctions (e.g., is affected by a virus or exhibits some other abnormal condition), other virtual objects may be prioritized based on their known relationship with the malfunctioning virtual object. For example, child objects of the malfunctioning virtual object may be given a higher priority level due to an increased likelihood that the child objects will “inherit” the malfunction. Display of the prioritized virtual objects (e.g., in a graph or a list) may enable more efficient diagnosis, containment, and repair of virtual object abnormalities.

In a particular embodiment, a method is disclosed that includes determining relationships between a plurality of virtual objects. The method also includes detecting an abnormal condition at a first virtual object of the plurality of virtual objects. The method further includes identifying a second virtual object based on a relationship between the second virtual object and the first virtual object, and identifying a third virtual object based on a relationship between the third virtual object and the first virtual object. For example, the second virtual object may be a child of the first virtual object and the third virtual object may be a parent of the first virtual object. An output is generated that identifies the first virtual object, the second virtual object, and the third virtual object. The output also indicates a priority level for each of the virtual objects. The priority level for the second virtual object is greater than the priority level for the third virtual object. For example, when the second virtual object is a child of the first virtual object and the third virtual object is a parent of the first virtual object, the priority level of the second virtual object may be higher than the priority level of the third virtual object because the probability that the second virtual object “inherited” the abnormal condition from the first virtual object is higher than the probability that the third virtual object “bequeathed” the abnormal condition to the first virtual object. Examples of inheritance relationships include, but are not limited to, “deploy,” “clone,” and “templatize.” Virtual objects may also have hierarchical relationships with each other, such as “sibling,” “descendant,” “distant relative,” and “unrelated.”

In another particular embodiment, a system is disclosed that includes a virtual object creation module configured to create a plurality of virtual objects, each virtual object having a relationship (e.g., an inheritance or contribution relationship) with one or more other virtual objects. The system also includes a pedigree controller configured to log the relationships between the plurality of virtual objects and a database including computer memory configured to store the logged relationships. The system further includes a detector configured to detect an abnormal condition. The system includes an output generator configured to generate an output that identifies each of the plurality of virtual objects, the relationships between the plurality of virtual objects, and a priority level for each of the plurality of virtual objects.

In a particular embodiment, the output generator includes a display interface configured to display a graph based on the logged relationships, where the graph shows the logged relationships. The graph includes a plurality of nodes and a plurality of edges, where each node represents a particular virtual object and each edge connecting a pair of nodes represents a particular relationship between a pair of virtual objects represented by the pair of nodes. The display interface is also configured to mark each node of the graph with an indication corresponding to a priority level. The priority level is based on a likelihood that the abnormal condition has affected the virtual object represented by the node. For example, virtual objects having a closer relationship to the virtual object having the abnormal condition may have a higher likelihood of being affected than virtual objects having a weaker relationship.

In another particular embodiment, a computer-readable medium is disclosed that includes instructions, that when executed by a computer, cause the computer to determine inheritance relationships between a plurality of virtual objects. The computer-readable medium also includes instructions, that when executed by the computer, cause the computer to display the plurality of virtual objects in a graph. The graph includes a plurality of nodes and a plurality of edges, where each node represents a particular virtual object and each edge connecting a pair of nodes represents a particular inheritance relationship between a pair of virtual objects represented by the pair of nodes. The computer-readable medium further includes instructions, that when executed by the computer, cause the computer to detect a security compromise at a first virtual object and color a first node representing the first virtual object a first color used to represent virtual objects associated with a first priority level. The computer-readable medium includes instructions, that when executed by the computer, cause the computer to color a second node representing a second virtual object a second color used to represent virtual objects associated with a second priority level, and to color a third node representing a third virtual object a third color used to represent virtual objects associated with a third priority level. The second virtual object is a child of the first virtual object, the third virtual object is a parent of the first virtual object, and the second priority level is higher than the third priority level.

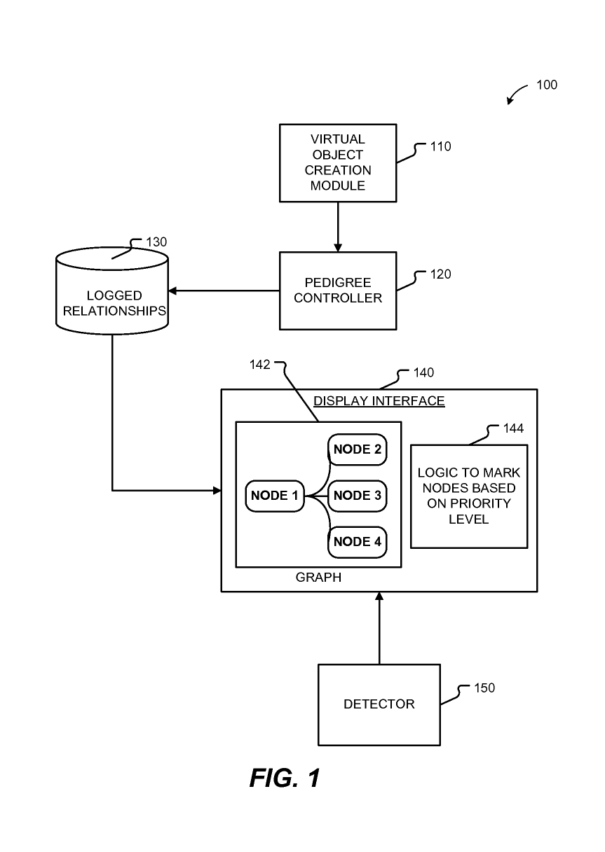

FIG. 1 is a block diagram to illustrate a particular embodiment of a system 100 to represent virtual object priority based on relationships. The system 100 includes a pedigree controller 120 communicatively coupled to a virtual object creation module 110 and a data store 130 configured to store logged relationships between virtual objects. The data store 130 is also communicatively coupled to a display interface 140. The display interface 140 is configured to receive input from a detector 150.

The virtual object creation module 110 is configured to create virtual objects. Virtual objects may include, but are not limited to, virtual machines, virtual machine templates, and ISO images. In a particular embodiment, when the virtual object creation module 110 creates a child virtual object based on one or more existing parent virtual objects, the child virtual object has a relationship with each of the one or more existing parent virtual objects. For example, when a new virtual machine is created based on an existing virtual machine, the two virtual machines have a “clone” relationship. As another example, when a new virtual machine is created based on a virtual machine template, the virtual machine and the virtual machine template are considered to have a “deploy” relationship. As another example, when a new virtual machine template is created based on an existing virtual machine, the virtual machine and the virtual machine template have a “templatize” relationship. Generally, when a first virtual object contributes at least in part to the creation of a second virtual object, the two may have a “contribution” relationship, where the first virtual object has “contributed” to the second virtual object. For example, a digital versatile disk (DVD) may have a “contribution” relationship with a software application if the DVD was previously used to install (e.g., via an ISO image on the DVD) the software application.

The pedigree controller 120 is configured to log relationships between virtual objects. For example, when a new child virtual machine C is created from an existing parent virtual machine M and an existing parent virtual machine template T, the pedigree controller 120 may log the “clone” relationship between C and M and the “deploy” relationship between C and T. In a particular embodiment, the pedigree controller 120 is configured to determine relationships between virtual objects based on virtual machine metadata, virtual machine files, and virtual machine creation logs. The pedigree controller 120 may send logged relationships to the data store 130 for storage. Logged relationships may be sent to the data store 130 in real-time, near real-time (e.g., real-time with allowances for acceptable processing delays), periodically, or in any other fashion. The data store 130 may be a relational database or any other form of data storage.

The detector 150 is configured to detect abnormal conditions in virtual objects created by the virtual object creation module 110. Examples of abnormal conditions include, but are not limited to, a malware infection, a network intrusion (e.g., unauthorized network-based access), an incorrect virtual object setting, and an error condition. In a particular embodiment, upon detecting an abnormal condition, the detector 150 sends a notification regarding the abnormal condition (e.g., the type of abnormality and where the abnormality was detected) to the display interface 140. In another particular embodiment, the detector 150 also sends a notification to system administrators (e.g., via e-mail or short message service (SMS)) regarding the detected abnormal condition. The detector 150 may include, or be coupled to, an anti-malware engine and a network firewall.

The display interface 140 is configured to display a graph 142 based on the logged relationships in the data store 130. In a particular embodiment, the graph 142 includes a plurality of nodes and a plurality of edges, where each node represents a virtual object and each edge connecting a pair of nodes represents a relationship between the virtual objects represented by the pair of nodes. For example, in the particular embodiment illustrated in FIG. 1, the graph 142 depicts that Node 1 has a relationship with each of Node 2, Node 3, and Node 4. The display interface 140 also includes logic 144 to mark the nodes of the graph 142 on the basis of priority level. In a particular embodiment, the priority level for a particular node is based on a likelihood that an abnormal condition detected by the detector 150 has affected the virtual object represented by the particular node. For example, when the detector 150 detects a malware infection in the virtual object represented by Node 1, the logic 144 may mark Node 1 with a first indication (e.g., a red coloring) corresponding to a first priority level (e.g., known to be infected) and one or more of Node 2, Node 3, and Node 4 with a second color (e.g., a yellow color) corresponding to a second priority level (e.g., possibly infected).

In a particular embodiment, the display interface 140 continuously refreshes the graph 142, effectively generating a real-time or near real-time view of virtual objects created by the virtual object creation module 110. Alternately, the display interface 140 may generate the graph 142 on demand (e.g., when requested by a system administrator) or as needed (e.g., when the detector 150 detects an abnormal condition). The display interface 140 may also update (sometimes called a “rebalance” operation) the graph 142 in real-time, near real-time, on demand, or as needed.

It should be noted that the display interface 140 is just one example of an output generator that may be present in the system 100. In other embodiments, the output generator may include a list generator configured to generate a prioritized list based on the relationships identified by the pedigree controller 120. For example, a prioritized list may be printed on paper, shown at an administrator's workstation display, or sent to an administrator in a security alert (e.g., via e-mail).

In operation, the virtual object creation module 110 may create virtual objects (e.g., virtual machines and virtual machine templates) and the pedigree controller 120 may identify relationships between the virtual objects and log the relationships in the data store 130. The display interface 140 may display the graph 142, providing a topological view of the virtual objects and the relationships. The detector 150 may monitor the virtual objects for abnormal conditions.

When the detector 150 detects an abnormal condition at a virtual object, the detector 150 may notify the display interface 140 of the abnormal condition. In response, the logic 144 to mark nodes based on priority level may mark the nodes of the graph 142 based on a priority level (e.g., a likelihood that the abnormal condition has affected the virtual objects represented by the nodes).

It should be noted that although the particular embodiment illustrated in FIG. 1 depicts the display interface 140 displaying the graph 142, the display interface 140 may instead format output in some other manner. For example, the display interface 140 may generate a prioritized list of virtual objects to be examined in response to the detected abnormal condition. In the malware infection example discussed above, Node 1 may be prioritized over Node 2, Node 3, and Node 4 because Node 1 is “known to be infected” whereas Node 2, Node 3, and Node 4 are “possibly infected.”

It will be appreciated that the system 100 of FIG. 1 may represent virtual object priority based on relationships such as contribution relationships and inheritance relationships. For example, when a security threat is detected at a particular virtual object, the system 100 of FIG. 1 may graphically represent the likelihood that the security threat has affected other virtual objects. Alternatively, the system 100 of FIG. 1 may generate a prioritized list of virtual objects to be examined (e.g., by IT specialists or system administrators) based on the security threat, where virtual objects that are more likely to be affected are prioritized over virtual objects that are less likely to be affected. It will thus be appreciated that by representing virtual object priority based on relationships, the system 100 of FIG. 1 may improve the speed and efficiency with which abnormal conditions in virtual objects are identified, contained, and cured.

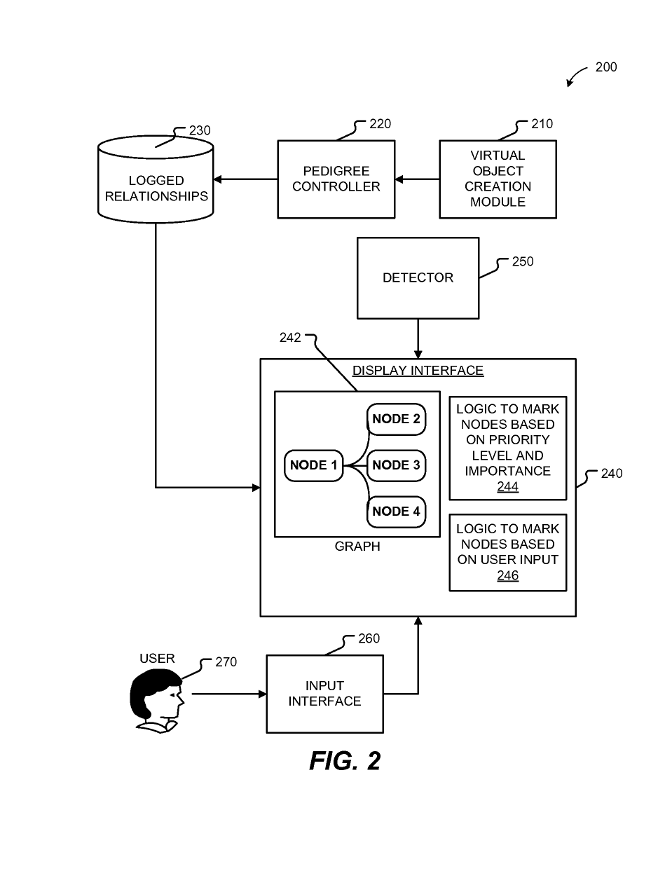

FIG. 2 is a block diagram to illustrate another particular embodiment of a system 200 to represent virtual object priority based on relationships. The system 200 includes a pedigree controller 220 communicatively coupled to a virtual object creation module 210 and a data store 230 configured to store logged relationships between virtual objects. The data store 230 is also communicatively coupled to a display interface 240. The display interface 240 is configured to receive input from a detector 250 and an input interface 260 useable by a user 270. In an illustrative embodiment, the virtual object creation module 210 is the virtual object creation module 110 of FIG. 1, the pedigree controller 220 is the pedigree controller 120 of FIG. 1, the data store 230 is the data store 130 of FIG. 1, the detector 250 is the detector 150 of FIG. 1, and the display interface 240 includes the display interface 140 of FIG. 1.

The virtual object creation module 210 may be configured to create virtual objects, for example in similar fashion as described above with respect to the virtual object creation module 110 of FIG. 1. As noted above with respect to the virtual object creation module 110 of FIG. 1, virtual objects may include, but are not limited to, virtual machines and virtual machine templates. In a particular embodiment, when the virtual object creation module 210 creates a child virtual object based on one or more existing parent virtual objects, the child virtual object has a relationship with each of the one or more existing parent virtual objects. For example, when a new virtual machine is created based on an existing parent virtual machine, the two may have a “clone” relationship. As another example, when a new virtual machine is created based on an existing parent virtual machine template, the two may have a “deploy” relationship. As another example, when a new virtual machine template is created based on an existing virtual machine, the two may have a “templatize” relationship. Generally, when a parent virtual object contributes at least in part to the creation of a child virtual object, the two may have a “contribution” relationship.

The pedigree controller 220 may be configured to log relationships between virtual objects. For example, when a new child virtual machine C is created from an existing parent virtual machine M and an existing parent virtual machine template T, the pedigree controller 220 may log the “clone” relationship between C and M and the “deploy” relationship between C and T. In a particular embodiment, the pedigree controller 220 is configured to determine relationships between virtual objects based on virtual machine metadata, virtual machine files, and virtual machine creation logs. The pedigree controller 220 may send logged relationships to the data store 230 for storage. Logged relationships may be sent to the data store 230 in real-time, near real-time, periodically, or in any other fashion. The data store 230 may be a relational database or any other form of data storage.

The detector 250 may be configured to detect abnormal conditions in virtual objects created by the virtual object creation module 210. Examples of abnormal conditions include, but are not limited to, a malware infection, a network intrusion, an incorrect virtual object setting, and an error condition. In a particular embodiment, upon detecting an abnormal condition, the detector 250 sends a notification regarding the abnormal condition (e.g., the type of abnormality and where the abnormality was detected) to the display interface 240. In another particular embodiment, the detector 250 also sends a notification to system administrators (e.g., via e-mail or SMS) regarding the detected abnormal condition. The detector 250 may include, or be coupled to, an anti-malware engine and a network firewall.

The display interface 240 may display a graph 242 based on the logged relationships in the data store 230. In a particular embodiment, the graph 242 includes a plurality of nodes and a plurality of edges, where each node represents a virtual object and each edge connecting a pair of nodes represents a relationship between the virtual objects represented by the pair of nodes. For example, in the particular embodiment illustrated in FIG. 2, the graph 242 depicts that Node 1 has a relationship with each of Node 2, Node 3, and Node 4.

The display interface 240 may include logic 244 to mark the nodes of the graph 242 on the basis of priority level and importance (e.g., based on a weighted average of numerical representations of priority and importance). In a particular embodiment, the priority level for a particular node is based on a likelihood that an abnormal condition detected by the detector 250 has affected the virtual object represented by the particular node. For example, when the detector 250 detects a malware infection in the virtual object represented by Node 1, the logic 244 may mark Node 1 with a first indication (e.g., a red coloring) corresponding to a first priority level (e.g., known to be infected) and one or more of Node 2, Node 3, and Node 4 with a second color (e.g., a yellow color) corresponding to a second priority level (e.g., possibly infected).

In another embodiment, when a particular node represents a particular virtual object in a multi-object system, the importance of the particular node is based on a relative importance of the particular virtual object in relation to other virtual objects of the multi-object system. For example, a node representing a mission-critical virtual object in the multi-object system may have a higher importance than nodes representing non mission-critical virtual objects. Nodes may be marked based on importance, based on likelihood of being compromised, or a combination of the two (e.g., a node border color corresponds to importance and a node body color corresponds to likelihood of being compromised).

The display interface 240 may also include logic 246 to mark nodes based on user input from the user 270 received via the input interface 260. For example, in the malware infection example above, the logic 246 may mark Node 4 a with third indication (e.g., a green color) in response to receiving user input that indicates that the virtual object represented by Node 4 has been examined by the user 270 (e.g., a system administrator) and is “known to be safe,” i.e., not infected by the malware.

In a particular embodiment, the display interface 240 continuously refreshes the graph 242, effectively generating a real-time or near real-time view of virtual objects created by the virtual object creation module 210. Alternately, the display interface 240 may generate the graph 242 on demand (e.g., when requested by a system administrator) or as needed (e.g., when the detector 250 detects an abnormal condition and when either of the logic 244 and 246 mark a node of the graph 242). The display interface 240 may also update (sometimes called a “rebalance” operation) the graph 242 in real-time, near real-time, on demand, or as needed.

A likelihood that a particular virtual object is affected by an abnormal condition may be determined in different ways. Certain virtual objects may be designed to be immune to certain types of abnormalities, resulting in a likelihood that the particular virtual object is affected to be zero. The likelihood of being affected may also be determined based on relationships such as “parent,” “child,” “sibling,” “descendant,” “distant relative,” and “unrelated.” The likelihood of being affected may also be determined based on the type of relationship (e.g., “deploy,” “clone,” “templatize,” and “contribution”).

In operation, the virtual object creation module 210 may create virtual objects (e.g., virtual machines and virtual machine templates) and the pedigree controller 220 may identify relationships between the virtual objects and log the relationships in the data store 230. The display interface 240 may display the graph 242, providing a topological view of the virtual objects and the relationships. The detector 250 may monitor the virtual objects for abnormal conditions.

When the detector 250 detects an abnormal condition at a virtual object, the detector 250 may notify the display interface 240 of the abnormal condition. In response, the logic 244 to mark nodes based on priority level may mark the nodes of the graph 242 based on priority level, importance, or both priority level and importance. When the user 270 provides input via the user interface 260 regarding a particular virtual object, the logic 246 to mark nodes based on user input may mark a particular node representing the particular virtual object based on the user input.

It should be noted that although the particular embodiment illustrated in FIG. 2 depicts the display interface 240 displaying the graph 242, the display interface 240 may instead format output in some other manner. For example, the display interface 240 may generate a prioritized list of virtual objects to be examined in response to the detected abnormal condition. In the malware infection example discussed above, Node 1 may be prioritized over Node 2, Node 3, and Node 4 because Node 1 is “known to be infected” whereas Node 2, Node 3, and Node 4 are “possibly infected.” When user input indicating that Node 4 is uninfected is received, Node 4 may be removed from the list altogether, because Node 4 is “known to be safe” based on the user input.

It will be appreciated that the system 200 of FIG. 2 may represent virtual object priority based on relationships. It will further be appreciated that the system 200 of FIG. 2 may modify virtual object priority based on priority level, importance, and user input, further improving the speed and efficiency with which abnormal conditions in virtual objects may be identified, contained, and cured.

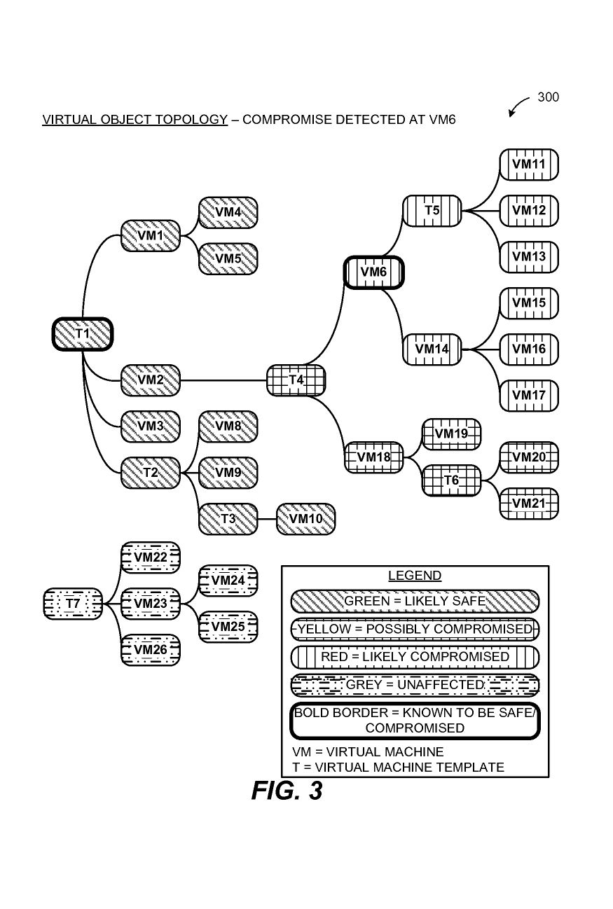

FIG. 3 is a graph 300 of an illustrative representation of virtual object priority based on relationships. The graph 300 represents a topological view of relationships between twenty-six virtual machines VM1-VM26 and seven virtual machine templates T1-T7. Each of the virtual machines and virtual machine templates is represented by a node of the graph 300, and each edge of the graph 300 represents a relationship. In an illustrative embodiment, the graph 300 is generated as described herein with respect to the graph 142 of FIG. 1 and the graph 242 of FIG. 2.

In the particular embodiment illustrated in FIG. 3, the graph supports marking nodes with one or more of five indications of virtual object priority. A green coloring for a node indicates that the virtual object represented by the node is likely safe from an abnormal condition. A yellow coloring for a node indicates that the virtual object represented by the node is possibly compromised by the abnormal condition. A red coloring for a node indicates that the virtual object represented by the node is likely compromised by the abnormal condition. A grey coloring for a node indicates that the virtual object represented by the node is unaffected by the abnormal condition. A bold border for a node indicates that the priority level of the virtual object represented by the node has been experimentally verified (e.g., diagnostic tests have confirmed whether or not the node has been affected by the abnormal condition), and therefore the virtual object is “known” to be safe or compromised.

The graph 300 indicates that an abnormal condition (e.g., a computer virus infection) has been detected at the virtual machine VM6. As a result, the node of the graph 300 representing the virtual machine VM6 has been colored red and has been outlined in a bold border. The graph 300 also indicates that the virtual machine template T1 is known to be uncompromised by the abnormal condition (e.g., the virtual machine template T1 may have been purposefully designed so as to be invulnerable to computer virus infections). As a result, the node of the graph 300 representing the virtual machine template T1 has been colored green and has been outlined in a bold border.

In a particular embodiment, since the virtual machine VM6 is known to be compromised, child virtual objects of the virtual machine VM6 may be “likely compromised.” In such an embodiment, the nodes representing the virtual machine template T5 and the virtual machines VM11, VM12, VM13, VM14, VM15, VM16, and VM17 may been colored red, as illustrated in FIG. 3.

In another particular embodiment, since the virtual machine VM6 is known to be compromised, any immediate parent of the virtual machine VM6, any siblings of the virtual machine VM6, and any descendants of the siblings of the virtual machine VM6 may be “possibly compromised.” In such an embodiment, the nodes representing the virtual machine templates T4 and T6 and the virtual machines VM18, VM19, VM20, and VM21 may be colored yellow, as illustrated in FIG. 3.

In another particular embodiment, any other distant relative virtual objects of the virtual machine VM6 may be “likely safe” due to relatively attenuated relationships with the virtual machine VM6. In such an embodiment, the nodes representing the virtual machine templates T2 and T3 and the virtual machines VM1, VM2, VM3, VM4, VM5, VM8, VM9, and VM10 may be colored green, as illustrated in FIG. 3

In another particular embodiment, any virtual objects that are unrelated to the virtual machine VM6 may be “unaffected” by any compromises in the virtual machine VM6. In such an embodiment, the nodes representing the virtual machine template T7 and the virtual machines VM22, VM23, VM24, VM25, and VM26 may be colored grey, as illustrated in FIG. 3.

It will thus be appreciated that the graph 300 of FIG. 3 may provide a topological view of virtual objects and provide visual indicators of the likelihood that a particular virtual object has been compromised by a detected abnormal condition. Thus, the graph 300 of FIG. 3 may be used by system administrators in responding to detected abnormal conditions such as malware infections and network intrusions.

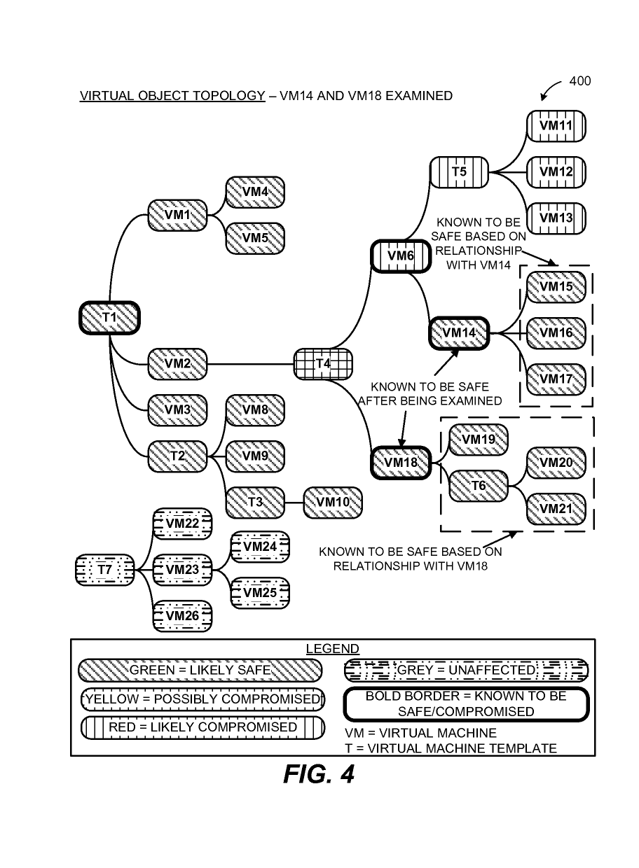

FIG. 4 is a graph 400 to illustrate a rebalancing of the graph 300 of FIG. 3 due to modified virtual object priorities. In an illustrative embodiment, the graph 400 of FIG. 4 is generated as described herein with respect to the graph 142 of FIG. 1, the graph 242 of FIG. 2, and the graph 300 of FIG. 3.

As described previously, system administrators may respond to abnormal conditions by examining virtual objects based on the abnormal conditions. In the particular embodiment illustrated in FIG. 4, a first system administrator has examined the virtual machine VM18 and has determined that the virtual machine VM18 is “safe” (i.e., unaffected by the detected abnormal condition). A notification of the “safe” status of the virtual machine VM18 may have been received via user input at a user interface, such as the user interface 260 of FIG. 2. In response to the user input, the graph 400 may be rebalanced and the node representing the virtual machine VM18 may be colored green and outlined in a bold border, as illustrated in FIG. 4. Status notifications may also be provided by other events or software intervention. For example, a virus scan initiated on a possibly infected virtual object may determine that the possibly infected virtual object is safe, and the virus scanning software may automatically update the graph with this information. Thus, virtual object health and recovery may be tracked without administrator intervention (e.g., even though a system administrator at a workstation is viewing the graph, the graph may be rebalanced without the system administrator having used any input device of the workstation).

Furthermore, in the particular embodiment illustrated in FIG. 4, the descendants of the virtual machine VM18 may be determined to be “likely safe” due to their descendancy from the virtual machine VM18 and lack of descendancy from the virtual machine VM 6. As a result, the nodes representing the virtual machine template T6 and the virtual machines VM19, VM20, and VM21 may automatically be colored green, as illustrated in FIG. 4.

In parallel with the first system administrator's examination of the virtual machine VM18, a second system administrator may examine the virtual machine VM14 and determine that the virtual machine VM14 is “safe.” As such, the graph 400 may be rebalanced and the node representing the virtual machine VM14 may be colored green and outlined in a bold border, as illustrated in FIG. 4. Furthermore, the nodes representing the descendants of the virtual machine VM14, i.e. the nodes representing the virtual machines VM15, VM16, and VM17, may be automatically colored green, as illustrated in FIG. 4.

It should be noted that although the nodes representing the descendants of the virtual machines VM14 and VM18 may automatically be colored green, the nodes are not marked with a bold border, because the fact that those virtual objects are “safe” has not been experimentally verified. At a subsequent time (e.g., after higher priority virtual objects represented by yellow and red nodes have been examined), the “safe” status of the descendants of the virtual machines VM14 and VM18 may be experimentally verified.

In a particular embodiment, performance of the rebalancing operation may be improved based on characteristics (e.g., read-only characteristics in the case of virtual machines and immutable characteristics in the case of virtual machine templates) of particular virtual objects. For example, if a child virtual machine is denoted (e.g., by virtual machine metadata) as read-only and has not changed since a parent of the child virtual machine has been examined, the child virtual machine may automatically be marked with the same indication(s) as the parent. As another example, a particular virtual machine template may have been designed as immutable (i.e., the state of the virtual machine template cannot be modified once the virtual machine template is created). In that case, immutable child virtual machine templates may automatically be marked with the same indication(s) as parent virtual objects.

It will thus be appreciated that the rebalancing of graphs (e.g., the graph 300 of FIG. 3 and the graph 400 of FIG. 4) may provide an updated topological view and indication of virtual object priority. It will further be appreciated that such rebalancing may support multiple users examining virtual objects in parallel and providing examination results (e.g., whether compromised or uncompromised) regarding the virtual objects.

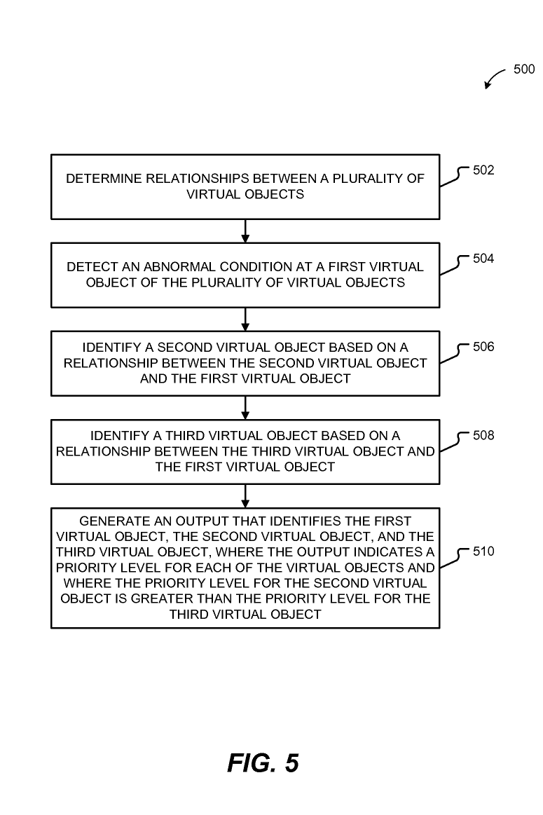

FIG. 5 is a flow diagram to illustrate a particular embodiment of a method 500 of representing virtual object priority based on relationships. In an illustrative embodiment, the method 500 may be performed by the system 100 of FIG. 1 or the system 100 of FIG. 2

The method 500 includes determining relationships between a plurality of virtual objects, at 502. For example, in FIG. 1, the pedigree controller 120 may determine relationships between virtual objects created by the virtual object creation module 110. Relationships may also be user-entered or software-specified (e.g., during an installation procedure). In an illustrative embodiment, the created virtual objects include the virtual machines VM1-VM26 and virtual machine templates T1-T7 illustrated in FIGS. 3-4.

The method 500 also includes detecting an abnormal condition at a first virtual object of the plurality of virtual objects, at 504. For example, in FIG. 1, the detector 150 may detect an abnormal condition at one of the virtual objects created by the virtual object creation module. In an illustrative embodiment, the abnormal condition is detected at the virtual machine VM6 as illustrated in FIGS. 3-4.

The method 500 further includes identifying a second virtual object based on a relationship between the second virtual object and the first virtual object, at 506. In an illustrative embodiment, the second virtual object is a child of the virtual machine VM6, such as the virtual machine template T5 as illustrated in FIGS. 3-4.

The method 500 includes identifying a third virtual object based on a relationship between the third virtual object and the first virtual object, at 508. In an illustrative embodiment, the third virtual object is a parent of the virtual machine VM6, such as the virtual machine template T4 as illustrated in FIGS. 3-4.

The method 500 also includes generating an output that identifies the first virtual object, the second virtual object, and the third virtual object, at 510. The output indicates a priority level for each of the virtual objects and the priority level for the second virtual object is greater than the priority level for the third virtual object. For example, in FIG. 1, the display interface 140 may generate the graph 142 and the logic 144 may mark nodes of the graph 142 based on priority level. In an illustrative embodiment, the graph 142 of FIG. 1 includes the graphs 300-400 as illustrated in FIGS. 3-4, where the virtual machine template T5 (colored red) has a higher priority level (likely compromised) than the virtual machine template T4 (colored yellow; possibly compromised).

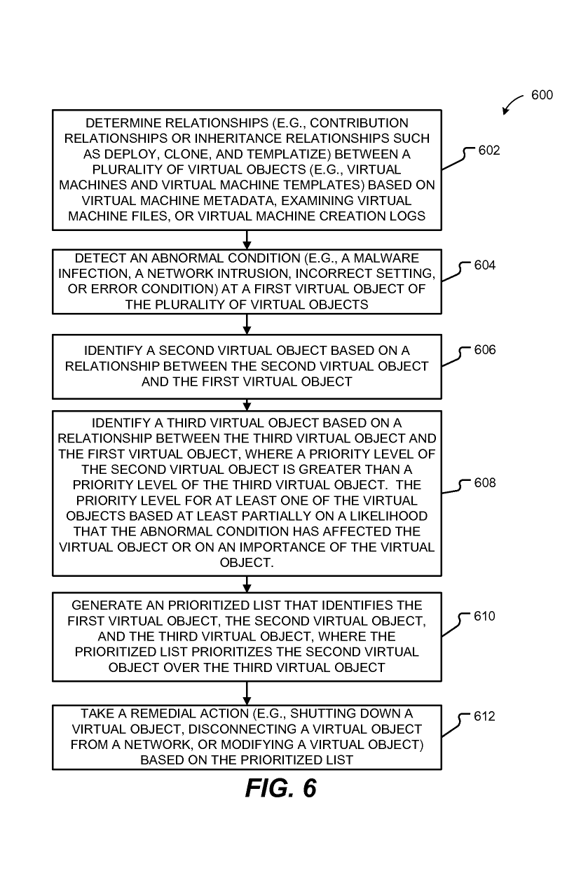

FIG. 6 is a flow diagram to illustrate another particular embodiment of a method 600 of representing virtual object priority based on relationships. In an illustrative embodiment, the method 600 may be performed by the system 100 of FIG. 1 or the system 100 of FIG. 2

The method 600 includes determining relationships between a plurality of virtual objects such as virtual machines or virtual machine templates, at 502. The relationships may include contribution relationships or inheritance relationships such as deploy, clone, and templatize. The relationships may be determined based on virtual machine metadata, virtual machine files, or virtual machine creation logs. For example, in FIG. 2, the pedigree controller 220 may determine relationships between virtual objects created by the virtual object creation module 210. In an illustrative embodiment, the created virtual objects include the virtual machines VM1-VM26 and virtual machine templates T1-T7 illustrated in FIGS. 3-4.

The method 600 also includes detecting an abnormal condition at a first virtual object of the plurality of virtual objects, at 604. The abnormal condition may be a malware infection, a network intrusion, an incorrect setting, or an error condition. For example, in FIG. 2, the detector 250 may detect an abnormal condition at one of the virtual objects created by the virtual object creation module. In an illustrative embodiment, the abnormal condition is detected at the virtual machine VM6 as illustrated in FIGS. 3-4.

The method 600 further includes identifying a second virtual object based on a relationship between the second virtual object and the first virtual object, at 606. In an illustrative embodiment, the second virtual object is a child of the virtual machine VM6, such as the virtual machine template T5 as illustrated in FIGS. 3-4.

The method 600 includes identifying a third virtual object based on a relationship between the third virtual object and the first virtual object, at 608. A priority level of the second virtual object is greater than a priority level of the third virtual object, and the priority level for at least one of the virtual objects is based on a likelihood that the abnormal condition has affected the virtual object or an importance of the virtual object. In a particular embodiment, the priority level may further be based on a degree that the abnormal condition has affected the virtual object (e.g., heavily affected or partially affected). In an illustrative embodiment, the third virtual object is a parent of the virtual machine VM6, such as the virtual machine template T4, and the virtual machine template T5 has a higher priority level (likely compromised) than the virtual machine template T4 (possibly compromised), as illustrated in FIGS. 3-4.

The method 600 also includes generating a prioritized list that identifies the first virtual object, and the third virtual object, at 610. The prioritized list prioritizes the second virtual object over the third virtual object. The output indicates a priority level for each of the virtual objects and the priority level for the second virtual object is greater than the priority level for the third virtual object. For example, a prioritized list may be generated that prioritizes the virtual machine template T5 over the virtual machine template T4.

The method 600 further includes taking a remedial action based on the prioritized list. The remedial action may include shutting down a virtual object, disconnecting a virtual object from a network, or modifying a virtual object. For example the virtual machine VM6 illustrated in FIGS. 3-4 may be shut down and disconnected from a network in an attempt to keep the abnormal condition from spreading to other virtual machines, and then restarted and reconnected to the network after the abnormal condition has been cured. Actions other than remedial actions may also be taken. For example, diagnostic actions may be taken. That is, when a particular virtual object is confirmed as affected by the abnormal condition, diagnostics and heuristics may be initiated at other virtual objects to determine how far the abnormal condition has spread.

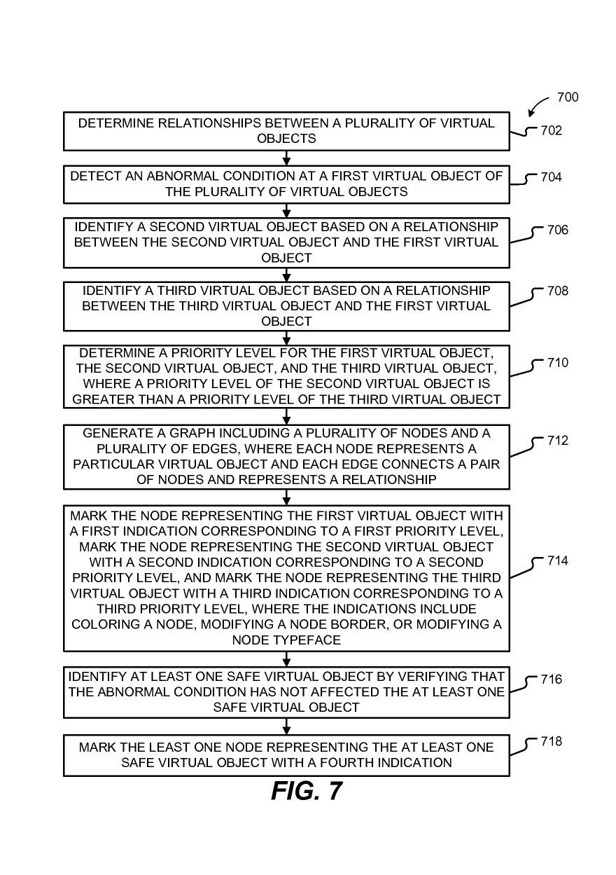

FIG. 7 is a flow diagram to illustrate another particular embodiment of a method 700 of representing virtual object priority based on relationships. In an illustrative embodiment, the method 700 may be performed by the system 100 of FIG. 1 or the system 100 of FIG. 2

The method 700 includes determining relationships between a plurality of virtual objects, at 702. For example, in FIG. 2, the pedigree controller 220 may determine relationships between virtual objects created by the virtual object creation module 210. In an illustrative embodiment, the created virtual objects include the virtual machines VM1-VM26 and virtual machine templates T1-T7 illustrated in FIGS. 3-4.

The method 700 also includes detecting an abnormal condition at a first virtual object of the plurality of virtual objects, at 704. For example, in FIG. 2, the detector 250 may detect an abnormal condition at one of the virtual objects created by the virtual object creation module. In an illustrative embodiment, the abnormal condition is detected at the virtual machine VM6 as illustrated in FIGS. 3-4.

The method 700 further includes identifying a second virtual object based on a relationship between the second virtual object and the first virtual object, at 706. In an illustrative embodiment, the second virtual object is a child of the virtual machine VM6, such as the virtual machine template T5 as illustrated in FIGS. 3-4.

The method 700 includes identifying a third virtual object based on a relationship between the third virtual object and the first virtual object, at 708. In an illustrative embodiment, the third virtual object is a parent of the virtual machine VM6, such as the virtual machine template T4 as illustrated in FIGS. 3-4.

The method 700 includes determining a priority level for the first virtual object, the second virtual object, and the third virtual object, at 710. A priority level for the second virtual object is greater than a priority level for the third virtual object. For example, the priority level for a particular virtual object may be determined based on a likelihood of being affected by the abnormal condition, a relative importance of the particular virtual object, or any combination thereof. The method 700 also includes generating a graph, at 712. The graph includes a plurality of nodes and a plurality of edges, where each node represents a particular virtual object and each edge connects a pair of nodes and represents a relationship. For example, in FIG. 2, the display interface 240 may generate the graph 242.

The method 700 further includes marking the node representing the first virtual object, the node representing the second virtual object, and the node representing the third virtual object, at 714. The first node is marked with a first indication corresponding to a first priority level, the second node is marked with a second indication corresponding to a second priority level, and the third node is marked with a third indication corresponding to a third priority level. Examples of indications include, but are not limited to, coloring a node, modifying a node border, and modifying a node typeface. For example, in FIG. 2, the logic 244 may mark nodes of the graph 242 based on priority level. In an illustrative embodiment, the graph 242 of FIG. 2 includes the graphs 300-400 as illustrated in FIGS. 3-4, where the virtual machine VM6 is colored red and outlined in a bold border, the virtual machine template T5 is colored red, and the virtual machine template T4 is colored yellow.

The method 700 includes identifying at least one safe virtual object by verifying that the abnormal condition has not affected the at least one safe virtual object, at 716. For example, in FIG. 2, the display interface 240 may receive input from the user interface 260 indicating that a particular virtual object is safe. In an illustrative embodiment, the safe virtual object is the virtual machine VM18 as illustrated in FIGS. 3-4.

The method 700 also includes marking the at least one node representing the at least one safe virtual object with a fourth indication, at 718. For example, in FIG. 2, the logic 246 may mark the nodes of the graph 242 based on the user input. In an illustrative embodiment, the graph 242 includes the graph 400 of FIG. 4, where the node representing the virtual machine VM18 is colored green and outlined in a bold border to indicate that the virtual machine VM18 is known to be safe.

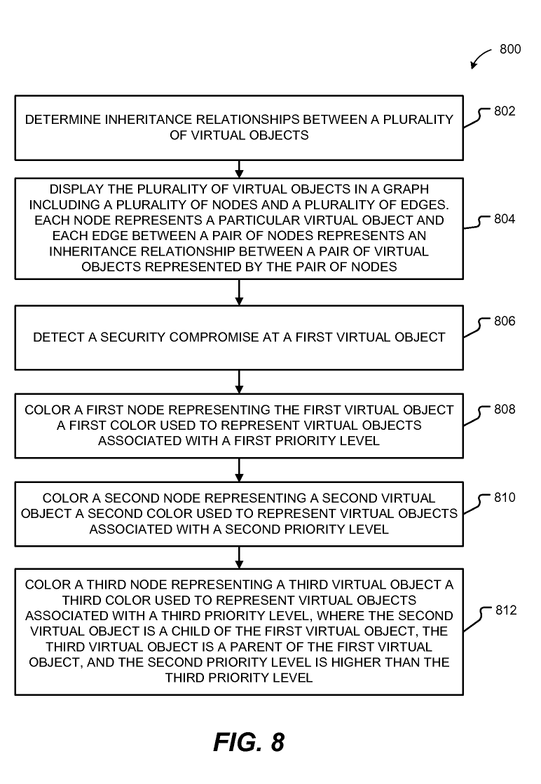

FIG. 8 is a flow diagram to illustrate another particular embodiment of a method 800 of representing virtual object priority based on relationships. In an illustrative embodiment, the method 800 is performed by the system 100 of FIG. 1 or the system 200 of FIG. 2.

The method 800 includes determining inheritance relationships between a plurality of virtual objects, at 802. For example, in FIG. 1, the pedigree controller 120 may determine inheritance relationships between a plurality of virtual objects created by the virtual object creation module 110. In an illustrative embodiment, the created virtual objects include the virtual machines VM1-VM26 and the virtual machine templates T1-T7 illustrated in FIGS. 3-4.

The method 800 also includes displaying the plurality of virtual objects in a graph, at 804. The graph includes a plurality of nodes and a plurality of edges. Each node represents a particular virtual object and each edge between a pair of nodes represents an inheritance relationship between a pair of virtual objects represented by the pair of nodes. For example, in FIG. 1, the display interface 140 may display the plurality of virtual objects in the graph 142.

The method 800 further includes detecting a security compromise at a first virtual object, at 806. For example, in FIG. 1, the detector 150 may detect a security compromise at a first virtual object. In an illustrative embodiment, the security compromise is detected at the virtual machine VM6 as illustrated in FIGS. 3-4.

The method 800 includes coloring a node representing the first virtual object a first color used to represent virtual objects associated with a first priority level, at 808. For example, in FIG. 1, the logic 144 may color a node of the graph 142 representing the first virtual object a first color. In an illustrative embodiment, the graph 142 includes the graph 300 of FIG. 3, where the node representing the virtual machine VM6 is outlined and colored in bold red, indicating that the virtual machine VM6 is known to be compromised.

The method 800 also includes coloring a second node representing a second virtual object a second color used to represent virtual objects associated with a second priority level, at 810. For example, in FIG. 1, the logic 144 may color a node of the graph 142 representing a second virtual object a second color. In an illustrative embodiment, the graph 142 includes the graph 300 of FIG. 3, where the node representing the virtual machine template T5 is colored red but not outlined in bold, indicating that the virtual machine template T5 is likely compromised.

The method 800 further includes coloring a third node representing a third virtual object a third color used to represent virtual objects associated with a third priority level, at 812. The second virtual object is a child of the first virtual object, the third virtual object is a parent of the first virtual object, and the second priority level is higher than the third priority level. For example, in FIG. 1, the logic 144 may color a node of the graph 142 representing a third virtual object with a third color. In an illustrative embodiment, the graph 142 includes the graph 300 of FIG. 3, where the node representing the virtual machine template T4 is colored yellow, indicating that the virtual machine template T4 is possibly compromised.

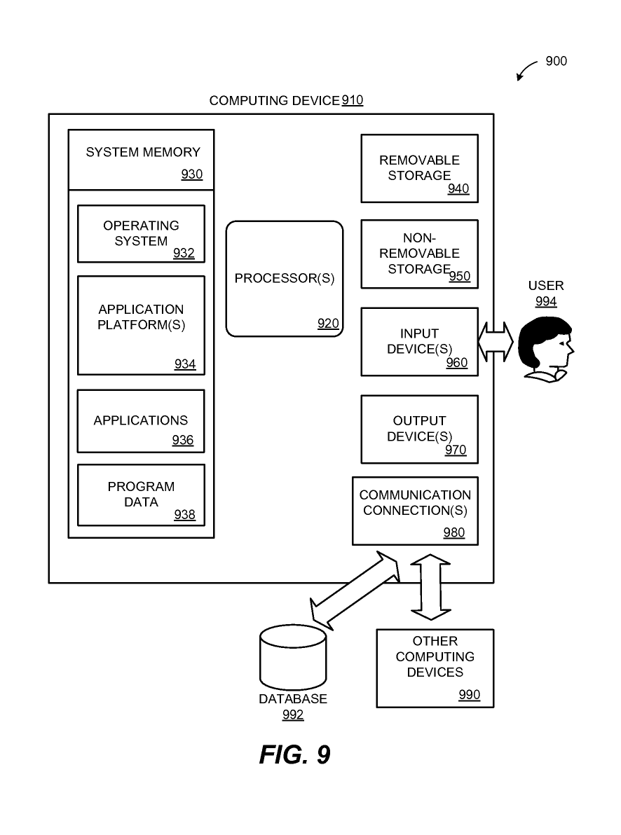

FIG. 9 shows a block diagram of a computing environment 900 including a computing device 910 operable to support embodiments of computer-implemented methods, computer program products, and system components according to the present disclosure. In an illustrative embodiment, the computing device 910 may one or more of the system components 110, 120, 130, 140, and 150 of FIG. 1 or the system components 21, 220, 230, 240, 250, and 260 of FIG. 2. Each of the components of the system 100 of FIG. 1 and the system 200 of FIG. 2 may include the computing device 910 or a portion thereof.

The computing device 910 typically includes at least one processor 920 and system memory 930. Depending on the configuration and type of computing device, the system memory 930 may be volatile (such as random access memory or “RAM”), non-volatile (such as read-only memory or “ROM,” flash memory, and similar memory devices that maintain stored data even when power is not provided) or some combination of the two. The system memory 930 typically includes an operating system 932, one or more application platforms 934, one or more applications 936, and may include program data 938. In an illustrative embodiment, the system memory 930 may include one or more modules or controllers as disclosed herein. For example, the system memory 930 may include one or more of the virtual object creation module 110 of FIG. 1, the pedigree controller 120 of FIG. 1, and the detector 150 of FIG. 1. As another example, the system memory 930 may include one or more of the virtual object creation module 210 of FIG. 2, the pedigree controller 220 of FIG. 2, and the detector 250 of FIG. 2.

The computing device 910 may also have additional features or functionality. For example, the computing device 910 may also include removable and/or non-removable additional data storage devices such as magnetic disks, optical disks, tape, and standard-sized or miniature flash memory cards. Such additional storage is illustrated in FIG. 9 by removable storage 940 and non-removable storage 950. Computer storage media may include volatile and/or non-volatile storage and removable and/or non-removable media implemented in any method or technology for storage of information such as computer-readable instructions, data structures, program components or other data. The system memory 930, the removable storage 940 and the non-removable storage 950 are all examples of computer storage media. The computer storage media includes, but is not limited to, RAM, ROM, electrically erasable programmable read-only memory (EEPROM), flash memory or other memory technology, compact disks (CD), digital versatile disks (DVD) or other optical storage, magnetic cassettes, magnetic tape, magnetic disk storage or other magnetic storage devices, or any other medium that can be used to store information and that can be accessed by computing device 910. Any such computer storage media may be part of the computing device 910. The computing device 910 may also have input device(s) 960, such as a keyboard, mouse, pen, voice input device, touch input device, etc. The input device(s) 960 may be used by a user 994 to communicate with the computing device 910. In an illustrative embodiment, the user 994 is the user 270 of FIG. 2. Output device(s) 970, such as a display, speakers, printer, etc. may also be included.

The computing device 910 also contains one or more communication connections 980 that allow the computing device 910 to communicate with other computing devices 990 and a database 992 over a wired or a wireless network. In an illustrative embodiment, the database 992 is the data store 130 of FIG. 1 or the data store 230 of FIG. 2.

The one or more communication connections 980 are an example of communication media. By way of example, and not limitation, communication media may include wired media such as a wired network or direct-wired connection, and wireless media, such as acoustic, radio frequency (RF), infrared and other wireless media. It will be appreciated, however, that not all of the components or devices illustrated in FIG. 9 or otherwise described in the previous paragraphs are necessary to support embodiments as herein described. For example, the output device(s) 970 may be optional.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Those of skill would further appreciate that the various illustrative logical blocks, configurations, modules, and process or instruction steps described in connection with the embodiments disclosed herein may be implemented as electronic hardware, computer software, or combinations of both. Various illustrative components, blocks, configurations, modules, or steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method described in connection with the embodiments disclosed herein may be embodied directly in hardware, in a software module executed by a processor, or in a combination of the two. A software module may reside in computer readable media, such as random access memory (RAM), flash memory, read only memory (ROM), registers, a hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor or the processor and the storage medium may reside as discrete components in a computing device or computer system.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The previous description of the embodiments is provided to enable any person skilled in the art to make or use the embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method comprising:
determining relationships between a plurality of virtual objects;
detecting an abnormal condition at a first virtual object of the plurality of virtual objects;
at a computer, identifying a second virtual object based on a relationship between the second virtual object and the first virtual object;
at the computer, identifying a third virtual object based on a relationship between the third virtual object and the first virtual object; and
at the computer, generating an output that identifies the first virtual object, the second virtual object, and the third virtual object, wherein the output indicates a priority level for each of the virtual objects and wherein the priority level for the second virtual object is greater than the priority level for the third virtual object.

2. The method of claim 1, wherein the priority level for at least one of the virtual objects is based at least partially on a likelihood that the abnormal condition has affected the at least one virtual object, an importance of the at least one virtual object, or any combination thereof.

3. The method of claim 1, wherein the plurality of virtual objects includes one or more virtual machines, one or more virtual machine templates, or any combination thereof.

4. The method of claim 3, wherein the relationships include one or more contribution relationships.

5. The method of claim 3, wherein the relationships include one or more inheritance relationships determined based on virtual machine metadata, virtual machine files, virtual machine creation logs, or any combination thereof.

6. The method of claim 5, wherein the one or more inheritance relationships include a deploy relationship between a parent virtual object template and a child virtual object, a clone relationship between a parent virtual object and the child virtual object, a templatize relationship between the parent virtual object and a child virtual object template, or any combination thereof.

7. The method of claim 1, wherein the detected abnormal condition at the first virtual object includes a malware infection, a network intrusion, an incorrect virtual object setting, an error condition, or any combination thereof.

8. The method of claim 1, further comprising taking an action based on the output, wherein the action includes shutting down a virtual object, disconnecting a virtual object from a network, modifying a virtual object, initiating diagnostic tools at a virtual object, performing heuristic analysis at a virtual object, or any combination thereof.

9. The method of claim 1, wherein the output includes a prioritized list of virtual objects to be examined in response to the detected abnormal condition, wherein the prioritized list prioritizes the second virtual object over the third virtual object.

10. The method of claim 1, wherein the output includes a graph comprising a plurality of nodes and a plurality of edges, wherein each node represents a particular virtual object, and wherein each edge connects a pair of nodes and represents a relationship between the pair of nodes.

11. The method of claim 10, wherein a node representing the first virtual object is marked with a first indication corresponding to a first priority level.

12. The method of claim 11, wherein a node representing the second virtual object is marked with a second indication corresponding to a second priority level.

13. The method of claim 12, wherein a node representing the third virtual object is marked with a third indication corresponding to a third priority level.

14. The method of claim 13, further comprising identifying at least one safe virtual object that is not affected by the abnormal condition, wherein at least one node representing the at least one safe virtual object is marked with a fourth indication and wherein the indications include coloring of a particular node, modifying a border of a particular node, modifying a typeface of a particular node, or any combination thereof.

15. A system comprising:
a virtual object creation module configured to create a plurality of virtual objects, each virtual object having a relationship with one or more other virtual objects;
a pedigree controller configured to log the relationships between the plurality of virtual objects;
a database including computer memory configured to store the logged relationships;
a detector configured to detect an abnormal condition; and
an output generator configured to generate an output that identifies each of the plurality of virtual objects, the relationships between the plurality of virtual objects, and a priority level for each of the plurality of virtual objects.

16. The system of claim 15, wherein the output generator includes a display interface configured to:
display a graph based on the logged relationships, the graph comprising a plurality of nodes and a plurality of edges, each particular node representing a particular virtual object and each particular edge connecting a pair of nodes and representing a particular relationship between a pair of virtual objects represented by the pair of nodes; and
mark each node of the graph with an indication corresponding to a priority level based on a likelihood that the abnormal condition has affected the virtual object represented by the node.

17. The system of claim 16, further comprising an input interface configured to receive input regarding whether particular virtual objects have been affected by the abnormal condition, wherein the display interface is further configured to mark one or more nodes of the graph representing the particular virtual objects based on the input, wherein the input is received from a user, via software executed by the system, without user intervention, or any combination thereof.

18. A computer-readable medium comprising instructions, that when executed by a computer, cause the computer to:
determine inheritance relationships between a plurality of virtual objects;
display the plurality of virtual objects in a graph comprising a plurality of nodes and a plurality of edges, wherein each node represents a particular virtual object and wherein each edge between a pair of nodes represents an inheritance relationship between a pair of virtual objects represented by the pair of nodes;
detect a security compromise at a first virtual object;
color a first node representing the first virtual object with a first color used to represent virtual objects associated with a first priority level;
color a second node representing a second virtual object with a second color used to represent virtual objects associated with a second priority level; and
color a third node representing a third virtual object with a third color used to represent virtual objects associated with a third priority level;
wherein the second virtual object is a child of the first virtual object, the third virtual object is a parent of the first virtual object, and the second priority level is higher than the third priority level.

19. The computer-readable medium of claim 18, further comprising instructions, that when executed by the computer, cause the computer to determine that a particular virtual object is not compromised and color a particular node representing the particular virtual object a fourth color associated with a fourth priority level.

20. The computer-readable medium of claim 19, wherein the determination that the particular virtual object is not compromised is made after examining the particular virtual object based on the security compromise, the examination performed by a user, anti-malware software, network security software, or any combination thereof and wherein the relationships are determined based on user input, software specification, or any combination thereof.
